(19) United States
(12) Patent Application Publication
(10) Pub. No.: US 2014/0375891 A1
(43) Pub. Date: Dec. 25, 2014

(54) DISPLAY DEVICE, AND TELEVISION RECEIVER DEVICE

(71) Applicant: Sharp Kabushiki Kaisha, Osaka (JP)

(72) Inventor: Mitsuru Hosoki, Osaka (JP)

(73) Assignee: Sharp Kabushiki Kaisha, Osaka (JP)

(21) Appl. No.: 14/374,460

(22) PCT Filed: Jan. 25, 2013
(86) PCT No.: PCT/JP2013/051548

§ 371 Date: Jul. 24, 2014

(30) Foreign Application Priority Data
Feb. 3, 2012 (JP) 2012-022104

(51) Int. Cl. F21V 8/00; H04N 5/44

(52) U.S. Cl. CPC G02B 6/009; G02B 6/0033; G02B 6/0081; H04N 5/44
USPC 348/725; 362/613; 349/65

(57) ABSTRACT

A display device 10 includes: light sources 17; a light guide plate 16 having a light-receiving face 16c and a light-exiting surface 16a, and a display panel 11 having a display surface 11a where light that exits the light-exiting surface 16a is used for image display; a driving substrate 113 having a mounting surface 113a on which the light sources 17 are mounted; flexible wiring substrates 111 that electrically connect the display panel 11 to the driving substrate 113; a chassis 14 having an extending edge 141 that extends beyond the light-receiving face 16c and that is arranged to face a surface 16b opposite to the light-exiting surface 16a; and a light source positioning member 18 that is detachably mounted on the chassis 14 and that is adhered to the driving substrate 113 such that the light sources 17 face the light-receiving face 16c with a gap therebetween.

### TECHNICAL FIELD

The present invention relates to a display device and a television receiver.

### BACKGROUND ART

Liquid crystal panels are used in display devices for televisions, mobile telephones, personal digital assistants, and the like. A liquid crystal panel has a liquid crystal layer and a pair of glass substrates that are bonded to sandwich this liquid crystal layer. These glass substrates each have prescribed electrodes formed thereon, and the alignment of the liquid crystal molecules in the liquid crystal layer is controlled by a driving voltage being applied between the electrodes. The driving voltage is controlled by a prescribed driving circuit.

A display device having a liquid crystal panel is also provided with an illumination device (a so-called backlight device) for supplying light to the liquid crystal panel. This illumination device is disposed on the rear surface side of the liquid crystal panel and illuminates the rear surface of the liquid crystal panel with planar light. As described above, if the alignment of the liquid crystal molecules in the liquid crystal layer is controlled, then the image displayed on the display surface of the liquid crystal panel is controlled by adjusting the proportion of light that passes from the rear surface side of the liquid crystal panel to the front.

A so-called edge-lit (side-lit) illumination device in which light sources such as LEDs are arranged facing an edge face of a light guide plate is known as such an illumination device described above. Patent Document 1 discloses an edge-lit illumination device in which LEDs are mounted on a printed-circuit board (driving board) used for driving control of a liquid crystal panel. The printed-circuit board is connected to an edge of the liquid crystal panel via a flexible substrate (TCP) and is arranged such that the mounting surface of the LEDs faces the edge faces of a light guide plate. Driving circuit chips that control the driving of the liquid crystal panel are mounted on the flexible substrate connected to the printed-circuit board. In Patent Document 1, mounting the LEDs on the printed-circuit board reduces the number of components and simplifies assembly work.

However, sometimes the liquid crystal panel is removed from the display device for repairs, a change of components, or the like. When the liquid crystal panel is removed, the flexible substrate and printed-circuit substrate attached to the edge of the liquid crystal panel will also be removed. Accordingly, as described above, if the LEDs are mounted on the printed-circuit substrate, then both the liquid crystal panel and the LEDs will be removed. The printed-circuit board where the LEDs are mounted is fixed to a chassis of the display device (illumination device) such that the LEDs face the edge faces of the light guide plate.

### RELATED ART DOCUMENT

### Patent Document

Patent Document 1: Japanese Patent Application Laid-Open Publication No. 2001-154191

### Problems to be Solved by the Invention

However, in order to remove the liquid crystal panel and the printed-circuit board having the LEDs mounted thereon from the display device, the light guide plate arranged on the rear surface side of the liquid crystal panel, the optical members stacked on this light guide plate, and the like must also be removed from the display device (illumination device). The positions of the light guide plate and optical members in the chassis are precisely controlled in consideration of thermal expansion/contraction and the like. Accordingly, once the light guide plate and the like are removed from the chassis, it is necessary to once again precisely position the light guide plate and the like.

### SUMMARY OF THE INVENTION

The present invention aims at providing a display device in which a display panel having a driving substrate with light sources mounted thereon is removed from a chassis with ease.

### Means for Solving the Problems

A display device of the present invention includes: light sources; a light guide plate having a light-receiving face on one edge face thereof that receives light emitted from the light sources, and a light-exiting surface on one surface of the light guide plate where light received by the light-receiving face exits, the light guide plate being a plate-shaped member; a display panel having a rear surface that faces the light-exiting surface of the light guide plate and that is illuminated by the light exiting from the light-exiting surface, and a display surface on a side opposite to the rear surface of the display panel, the display surface being where images are displayed by the light illuminating the rear surface; a driving substrate having a mounting surface on which the light sources are mounted, the driving substrate driving display of the display panel; flexible wiring substrates that electrically connect the display panel to the driving substrate; a chassis that has an extending edge that extends beyond the light-receiving face of the light guide plate and that faces a surface of the light guide opposite to the light-exiting surface; and a light source positioning member that is detachably mounted on the chassis and that is adhered to a surface of the driving substrate opposite to the mounting surface thereof such that the light sources face the light-receiving face with a prescribed gap therebetween. In the above-mentioned display device, the light sources are mounted on the mounting surface of the driving substrate that drives display of the display panel. The driving substrate is electrically connected to the display panel by the flexible wiring substrates. The light source positioning member is adhered to the opposite side of the mounting surface of the driving substrate such that the light sources face the light-receiving face of the light guide plate with a prescribed gap maintained therebetween. The light source positioning member is detachable from the extending edge of the chassis. Accordingly, in the display device, the driving substrate can be removed from the chassis with ease during removal of the display panel.

In the display device, the light source positioning member may be detachably fixed to the chassis. In the display device, if the light source positioning member is detachably fixed to the chassis, then the driving substrate can be removed from the chassis with ease if the light source positioning member is detached from the chassis.

In the display device, the light source positioning member may have a first positioning section adhered to a surface of the driving substrate opposite to the mounting surface thereof, and a first attachment section that extends to this first positioning section and that is detachably fixed to the chassis.

In the display device, a bottom of the driving substrate may be sandwiched between the first positioning section and the extending edge and supported by the first attachment section. In the display device, if the bottom of the driving substrate is sandwiched between the first positioning section and the extending edge and supported by the first attachment section, then the position of the driving substrate can be reliably positioned by the light source positioning member.

In the driving device, the first positioning section and the first attachment section may both have plate shapes and be perpendicular to each other.

The display device may further include a frame-shaped bezel that covers a periphery of the display panel such that the display surface is exposed, and the light source positioning member may be a part of the bezel. In the display device, if the light source positioning member is a part of the bezel, then the light source positioning member can be detached from the chassis along with the bezel. As a result, the driving substrate can be detached from the chassis with ease.

The display device may further include a frame-shaped bezel that covers a periphery of the display panel such that the display surface is exposed, and the light source positioning member may be detachably fixed to the bezel. In the display device, if the light source positioning member is detachably fixed to the bezel, then when the display panel is being removed from the display device, the bezel alone can be removed from the chassis side if the bezel is detached from the light positioning member ahead of time. Accordingly, the light source positioning member is removed from the chassis with ease. Furthermore, if the light source positioning member is detached from the bezel, then the light source positioning member becomes easier to attach to the chassis side during assembly of the display device.

The display device may further include an adhesive sheet that is interposed between the light source positioning member and the driving substrate and that adheres the driving substrate to the light source positioning member.

In the display device, the adhesive sheet may have an interposed adhesive part that is interposed between the light source positioning member and the driving substrate and an extended adhesive part extending from this interposed adhesive part and adhered to the extending edge. If the adhesive sheet has the interposed adhesive part and the extended adhesive part, then the driving substrate is reliably positioning with respect to the chassis by the adhesive sheet.

In the display device, the adhesive sheet may have thermally conductive characteristics. If the adhesive sheet has thermally conductive characteristics, then the heat generated from the substrate side can be efficiently transferred to the light source positioning member side via the adhesive sheet.

In the display device, the driving substrate may include a rising portion that rises from the chassis and that includes the mounting surface, and an extended fixture that continues from this rising portion and that is detachably fixed to the extending edge, the rising portion being in contact with the extending edge. If the driving substrate has the rising portion and the extended fixture, then it is easy to arrange the driving substrate such that the light sources face the light-receiving face of the light guide plate with while maintaining a prescribed gap therebetween.

The display device may further include a protective member that has: a body arranged between the mounting surface of the driving substrate and the light-receiving face of the light guide plate; insertion sections that are holes going through this body and that are where the respective light sources are inserted; and a protective wall that surrounds the insertion sections such that the light sources do not protrude into the light-receiving face of the light guide plate. If the display device has the protective member, then when the protective member, to which the driving substrate is attached, is attached to the chassis, the light sources mounted on the mounting surface of the driving substrate are suppressed from making contact with the light-receiving face of the light guide plate. As a result, damage and the like of the light sources is suppressed.

The display device may further include a frame that attaches to a periphery of the liquid crystal display panel from the rear surface side thereof, and the protective member may be a part of the frame. If the protective member is a part of the frame, then the body of the protective member is easy to arrange between the mounting surface and the light-receiving face.

In the display device, the display panel may be a liquid crystal panel having liquid crystal sealed between a pair of substrates.

A television receiver according to the present invention includes the display device.

### Effects of the Invention

According to the present invention, a display device can be provided in which a display panel having a driving substrate with light sources mounted thereon is removed from a chassis with ease.

### BRIEF DESCRIPTION OF THE DRAWINGS

FIG. 1 is an exploded perspective view of a schematic configuration of a television receiver according to Embodiment 1 of the present invention.

FIG. 2 is an exploded perspective view showing a schematic configuration of a liquid crystal display device.

FIG. 3 is a cross-sectional view along the line A-A′ of FIG. 2.

FIG. 4 is an enlarged view of the cross-sectional view of FIG. 3.

FIG. 5 is a schematic view for explaining a detaching process of a liquid crystal panel from a backlight device.

FIG. 6 is a cross-sectional view of a liquid crystal display device of Embodiment 2.

FIG. 7 is a cross-sectional view of a liquid crystal display device of Embodiment 3.

FIG. 8 is a cross-sectional view of a liquid crystal display device of Embodiment 4.

FIG. 9 is a cross-sectional view of a liquid crystal display device of Embodiment 5.

FIG. 10 is a cross-sectional view of a liquid crystal display device of Embodiment 6.

FIG. 11 is a perspective view of a frame of Embodiment 7.

FIG. 12 is a view explaining a protective member of the frame.

FIG. 13 is a cross-sectional view of a liquid crystal display device of Embodiment 7.

FIG. 14 is a schematic view for explaining a detaching process of a liquid crystal panel from a backlight device according to Embodiment 7.

### DETAILED DESCRIPTION OF EMBODIMENTS

### Embodiment 1

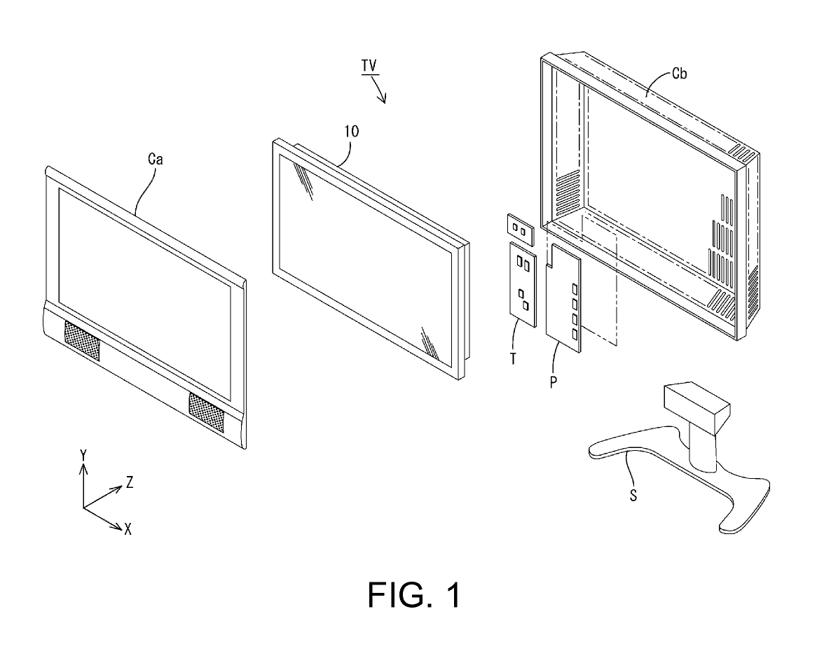

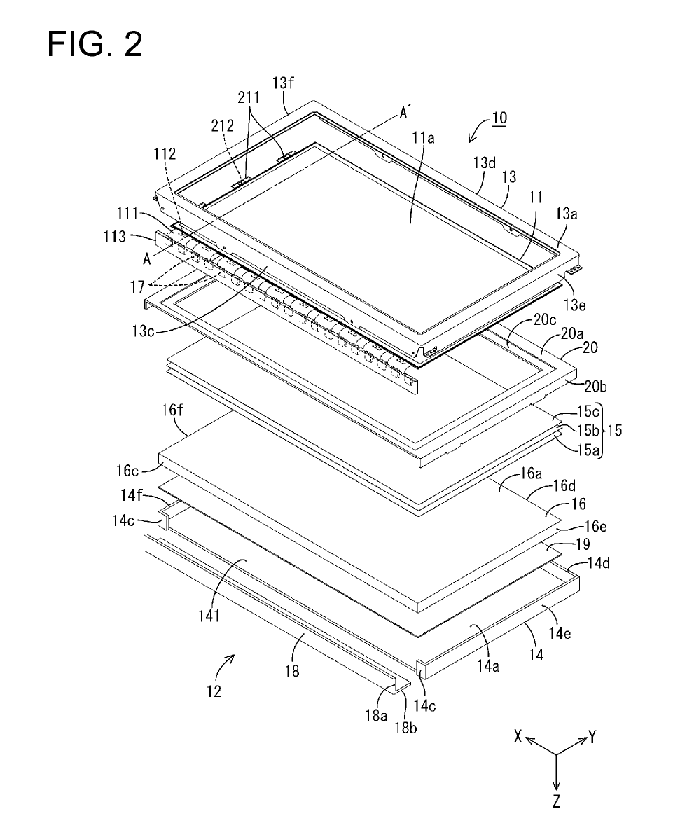

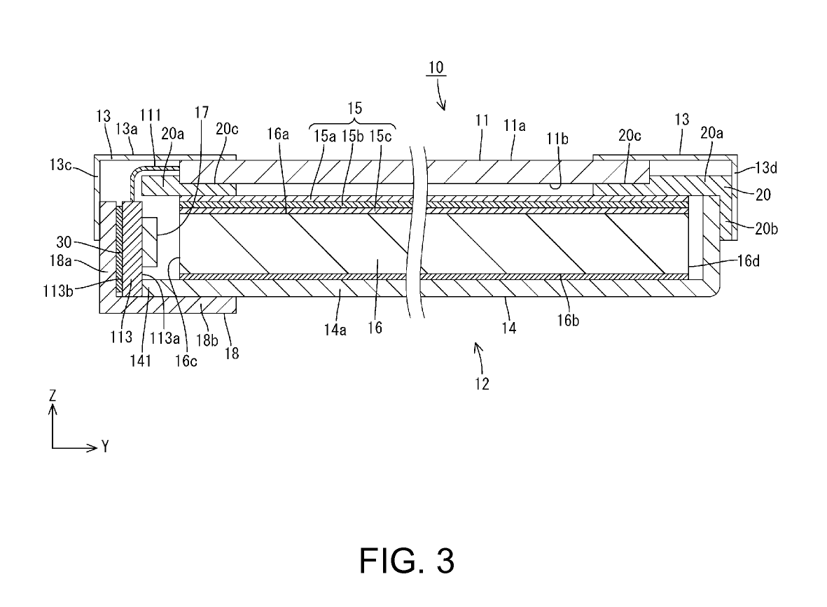

Embodiment 1 of the present invention will be explained below with reference to FIGS. 1 to 5. In the present embodiment, a liquid crystal display device 10 used with a television receiver TV will be described as examples. The respective drawings have an X axis, a Y axis, and a Z axis, and the drawings are depicted such that the directions of the axes in the respective drawings match. The upper side of FIGS. 2 and 3 is the front side, and the lower side is the rear side.

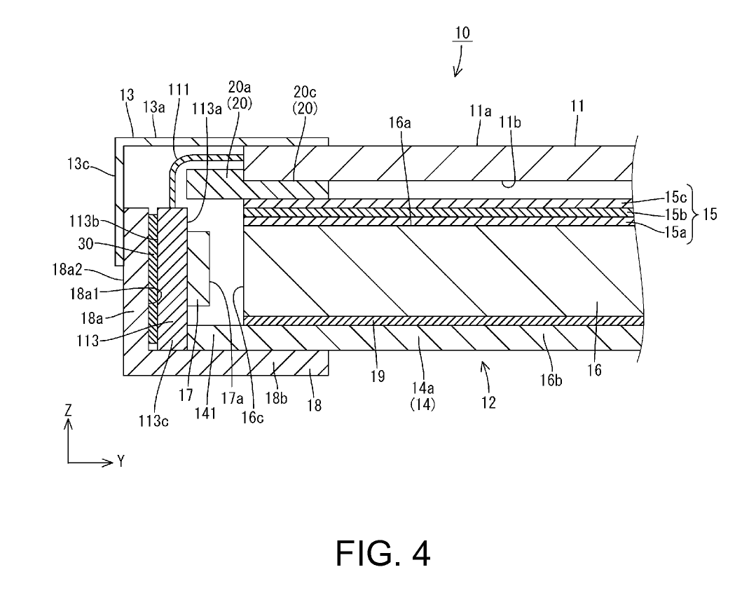

FIG. 1 is an exploded perspective view showing a schematic configuration of the television receiver according to Embodiment 1 of the present invention. As shown in FIG. 1, the television receiver TV of the present embodiment includes the liquid crystal display device 10, a front and a back cabinet Ca and Cb that sandwich the liquid crystal display device 10 to house it therebetween, a power source P, a tuner T, and a stand S. The liquid crystal display device (display device) 10 has a horizontally-long rectangular shape as a whole and is housed between the cabinets Ca and Cb with the display surface of the liquid crystal display device upright. FIG. 2 is an exploded perspective view of a schematic configuration of the liquid crystal display device 10, FIG. 3 is a cross-sectional view of FIG. 2 along the line A-A′, and FIG. 4 is an enlarged view of the cross-sectional view of FIG. 3. As shown in FIG. 2, the liquid crystal display device 10 includes a liquid crystal panel (display panel) 11, a backlight device (illumination device) 12 that is an external light source, and a bezel 13. The bezel 13 is a frame-shaped member made of metal, and is attached to the liquid crystal display device 10 in a state covering the periphery of the liquid crystal panel 11.

The liquid crystal panel 11 is formed in a rectangular shape in a plan view, and a pair of glass substrates is bonded together with a prescribed gap therebetween. Liquid crystal is sealed between this pair of glass substrates. Of these substrates, one of the glass substrates that is disposed on the rear surface side (back) is a so-called thin film transistor (hereinafter, TFT) array substrate, and the other glass substrate disposed on the display surface side (front) is a so-called color filter (hereinafter, CF) substrate.

As shown in FIG. 2, the liquid crystal panel 11 overall has a horizontally-long rectangular shape in a plan view as viewed from the front. The liquid crystal panel 11 mainly includes a pair of transparent glass substrates that face each other, and a liquid crystal layer sealed therebetween. Of these substrates, one of the glass substrates that is disposed on a rear surface 11b side (back) is a so-called thin film transistor (hereinafter, TFT) array substrate, and the other glass substrate disposed on a display surface 11a side (front) is a so-called color filter (hereinafter, CF) substrate.

The TFT array substrate mainly includes a plurality of TFTs that are switching elements on a transparent glass plate, and a plurality of transparent pixel electrodes electrically connected to the drain electrodes of the respective TFTs and arranged in a matrix (in rows and columns). The individual TFTs and pixel electrodes are provided for the respective pixels, each of which is delineated by a plurality of gate wiring lines and a plurality of source wiring lines provided on the glass plate so as to intersect each other. The gate electrodes of the respective TFTs are connected to the gate wiring lines, and the source electrodes of the respective TFTs are connected to the source wiring lines. Capacitance wiring lines (auxiliary capacitance lines, storage capacitance lines, Cs lines) are also provided on the TFT array substrate. These capacitance wiring lines are disposed parallel to the respective gate wiring lines and overlap the respective pixel electrodes in a plan view. The capacitance wiring lines and gate wiring lines are disposed parallel to each other and alternately arranged.

The CF substrate is mainly configured such that CFs of respective colors such as red (R), green (G), and blue (B) are arranged in a matrix on a transparent glass plate so as to correspond to the respective pixels on the TFT array substrate. The respective CFs are delineated by a light-shielding black matrix (BM) provided in a grid pattern on the glass plate. A transparent opposite electrode or the like is provided on the CFs and the BM so as to face the pixel electrodes on the TFT array substrate. Polarizing plates are respectively disposed on the display surface 11a side and the rear surface 11b side of the liquid crystal panel 11 so as to sandwich the pair of glass substrates.

The TFT array substrate is configured to be slightly larger than the CF substrate. As a result, the edges of the TFT array substrate stick out from the edges of the CF substrate when the TFT array substrate and the CF substrate are bonded together. A plurality of source terminals (not shown) continuing from the source wiring lines described above are disposed on one long-side edge of the TFT array substrate. As shown in FIGS. 2 and 3, flexible substrates 111 are connected to the respective source terminals. The respective flexible substrates 111 connect to the source terminals while being arranged in a row with prescribed gaps therebetween along one long-side edge of the liquid crystal panel 11 (TFT array substrate). The respective flexible substrates 111 extend outward from the one long-side edge of the TFT array substrate.

Each of the flexible substrates 111 has a film-like base material made of a synthetic resin material (a polyimide resin, for example) having insulating and flexible characteristics, and a driver (source driver IC) 112, for driving liquid crystal, mounted near the center of this base material. For convenience of explanation, the driver 112 is omitted in FIG. 3 and the like. A plurality of wiring patterns are formed on the base material of the respective flexible substrates 111, and the drivers 112 are connected to these wiring patterns. In the present embodiment, the flexible substrates 111 are so-called SOF (system on film) modules. One edge of the flexible substrates 111 has a crimp connection with the respective source terminals on the TFT array substrate via an anisotropic conductive film (ACF). The other edge of the flexible substrates 111 has a crimp connection with terminals (not shown) of a driving substrate 113 described later via an anisotropic conductive film (ACF).

The driving substrate 113 controls display driving of the liquid crystal panel 11 by supplying a prescribed image signal (a scan signal to a gate wiring line, a data signal to a source wiring line, or a capacitance signal to a capacitance wiring line, for example) to the liquid crystal panel 11 (TFT array substrate) via the flexible substrates 111. The driving substrate 113 is connected to a controller substrate (not shown) via a prescribed wiring member (FPC: flexible printed circuit board). The controller substrate functions to convert externally supplied image signals into liquid crystal driving signals and to supply these converted image signals to the driving substrate 113. The driving substrate 113 supplies prescribed signals (data signals to source wiring lines) to the respective source terminals via the flexible substrates 111. The driving substrate 113 has a plate shape (belt shape) that is elongated as a whole along the long-side direction of the liquid crystal panel 11. The edges of the respective flexible substrates 111 are connected to this long-side edge of the driving substrate 113. The length of the entire driving substrate 113 is approximately the same as the length of the long-side of the liquid crystal panel 11. As described later, a plurality of LEDs 17 are mounted on the driving substrate 113.

A plurality of gate terminals (not shown) continuing from the gate wiring lines and capacitance wiring lines described above are disposed on one short-side edge of the TFT array substrate. As shown in FIG. 2, flexible substrates 211 are connected to the respective gate terminals. The respective flexible substrates 211 connect to the gate terminals while being arranged in a row with prescribed gaps therebetween along one short-side edge of the liquid crystal panel 11 (TFT array substrate). The respective flexible substrates 211 extend outwards from the one short-side edge of the TFT array substrate. Each of the flexible substrates 211 has a film-like base material made of a synthetic resin material (a polyimide resin, for example) having insulating and flexible characteristics, and a driver gate driver IC) 212, for driving liquid crystal, mounted near the center of this base material. A plurality of wiring patterns are formed on the base material of the respective flexible substrates 111, and the drivers 212 are connected to these wiring patterns. These flexible substrates 212 are SOF modules.

A relay wiring line (not shown) that connects the source terminals to the gate terminals is formed on the TFT array substrate. Accordingly, the signals (scan signals to gate wiring lines, capacitance signals to capacitance wiring lines, and the like) supplied by the controller substrate described above are transmitted to the gate terminals and flexible substrates 212 via the driving substrate 113, the flexible substrates 111, and the relay wiring line. With this type of configuration, the liquid crystal panel 11 displays images on the display surface 11a on the basis of prescribed signals supplied by the driving substrate 113.

The driving substrate 113 has a mounting surface 113a where the LEDs are mounted and an opposite surface 113b that is opposite to (on the rear of) this mounting surface 113. The mounting surface 113a has a rectangular shape that is elongated along the long-side direction of the liquid crystal panel 11, and a plurality of the LEDs 17 are mounted thereon in a row with prescribed gaps (at regular intervals) therebetween. The LEDs 17 are constituted by a plurality of LED chips that are light-emitting elements respectively sealed in a housing by a resin material or the like (so-called LED packages). The LEDs 17 are configured so as to emit white light. The LEDs 17 are constituted of three types of embedded LED chips of different primary emission wavelengths, for example, and specifically, the LED chips each emit a single color of red (R), green (G), or blue (B). The LEDs 17 are not limited to this configuration, and may be another configuration. The other configuration of the LEDs 17 may be one in which an LED chip that only emits a blue color (B) is embedded and covered by a resin (a silicon-based resin, for example) having a phosphor with a light-emitting peak in a red color (R) region and a phosphor with a light-emitting peak in a green color (G) region mixed together (a silicon-based resin, for example). Another configuration may be one in which an LED chip that emits only a blue color (B) is embedded and covered by a resin (a silicon-based resin, for example) having a phosphor that emits yellow light such as a YAG (yttrium aluminum garnet) phosphor mixed therein. The external appearance of the LEDs 17 when mounted on the mounting surface 113a is a substantially rectangular cuboid shape. Parameters such as the number of LEDs 17 mounted on the mounting surface 113a of the driving substrate 113 and the distance between the adjacent LEDs 17 are configured as appropriate.

The driving substrate 113 has an elongated (belt-shaped) base material, an insulating layer made of a synthetic resin formed on this base material, wiring patterns made of a metal film such as copper foil formed on this insulating layer, and a reflective layer made of a white insulating film formed on this insulating layer so as to cover these wiring patterns. For convenience of explanation, in FIG. 2 and the like, the base material, insulating layer, wiring patterns, and reflective layer on the driving substrate 113 are shown as a single structure. The mounting surface 113a described above indicates the surface of the driving substrate 113 on the side where the LEDs 17 are mounted, and the opposite face 113b is the surface (rear surface) of the driving substrate 113 where the LEDs 17 are not mounted. The base material is made of a metal such as aluminum, a ceramic material, or the like. The respective LEDs 17 on the driving substrate 113 are connected in series by the wiring patterns. Both terminals of the wiring patterns connected to the LEDs 17 are electrically connected to an LED driving circuit substrate (not shown) and driving power is supplied as appropriate to the respective LEDs 17 from this LED driving circuit substrate. Some of the wiring patterns are used for illumination driving of the LEDs 17, and some are used for driving display of the liquid crystal panel 11 described above.

As shown in FIG. 2, the backlight device (illumination device) 12 mainly includes a chassis 14, optical members 15, a light guide plate 16, the LEDs 17 mounted on the driving substrate 113, a light source positioning member 18, a reflective sheet 19, and a frame 20.

The chassis 14 is a tray-shaped box with the upper surface and one side open, and is formed by press-treating or the like a plate material made of a metal such as an aluminum-type material. This chassis 14 has a bottom plate 14a that has a horizontally-long rectangular shape when viewed from the front in a plan view, two small side walls 14c with a gap therebetween on one long-side end of this bottom plate 14a, a large side wall 14d on the other long-side end of the bottom plate 14a, and side walls 14e and 14f on the respective short-side ends of the bottom plate 14a. The respective side walls 14c, 14d, 14e, and 14f rise from the bottom plate 14a and surround the bottom plate 14a. Among the edges of the bottom plate 14a, the edge where the small side wall 14c is arranged is sometimes called an extending edge 141.

The light source positioning member 18 is a member to which the driving substrate 113 where the LEDs 17 are mounted is fixed, and is formed by the same metal material as the chassis 14 being formed into a prescribed shape. The light source positioning member 18 attaches to the chassis 14 while blocking the side of the chassis 14 that is open. As shown in FIG. 2 and the like, the light source positioning member 18 is a plate-shaped member with an “L”-shape in a cross section as a whole, and extends along the long-side direction of the chassis 14. The light source positioning member 18 has a first positioning section 18a and a first attaching section 18b. The first positioning section 18a is a plate-shaped section that is upright with respect to the bottom plate 14a and is the section where the driving substrate 113 is attached. A double-sided adhesive sheet 30 that is thermally conductive is attached to an inner face 18a1 of the first positioning section 18a, and the driving substrate 113 is fixed to the first positioning section 18a through this adhesive sheet 30. The adhesive sheet 30 is adhered to the opposite face 113b of the driving substrate 113. This adhesive sheet 30 has enough adhesive strength to adhere the driving substrate 113 to the first positioning section 18a, but if external force beyond a prescribed value is exerted on the adhesive sheet 30, then the adhesive sheet 30 can be peeled from respective members such as the driving substrate 113 and the first positioning section 18a (the light source positioning member 18).

The bezel 13 is fixed to an outer face of the first positioning section 18a by a fixing structure (not shown) such as a screw. The bezel 13 is fixed in such a way as to be detachable (removable). Furthermore, the first attaching section 18b is a plate-shaped section that extends along the outer surface of the bottom plate 14a and is fixed to this bottom plate 14a of the chassis 14 by a fixing structure (not shown) such as a screw in such a way that the first attaching section 18b is detachable (removable). The respective ends of the first attaching section 18b and the first positioning section 18a connect to each other, and the first attaching section 18b and the first positioning section 18a are perpendicular to each other.

The reflective sheet 19 has a horizontally-long rectangular shape when viewed from the front in a plan view, in a manner similar to the chassis 14, and is a white foamed plastic sheet with excellent reflective characteristics (a foamed polyethylene terephthalate sheet, for example). This reflective sheet 19 is housed in the box-shaped chassis 14 so as to cover the surface (plate surface) of the bottom plate 14a of the chassis 14.

As shown in FIG. 2, the light guide plate 16 has a horizontally-long rectangular shape when viewed from the front in a plan view, in a manner similar to the liquid crystal panel 11 and the chassis 14, and is a plate-shaped member having a prescribed thickness. The light guide plate 16 is manufactured from a synthetic resin material (an acrylic resin such as PMMA or a polycarbonate resin, for example) that has a refractive index significantly higher than air and that is substantially transparent (having excellent transmissive characteristics). The light guide plate 16 has a front surface 16a, a rear surface 16b opposite to this front surface 16a, two edge faces 16c and 16d along the long-sides of the light guide plate 16, and two edge faces 19e and 19f along the short-sides of the light guide plate 16. In the present embodiment, one of the side edges 16c on the long-side of the light guide plate 16 is the light-receiving face 16c that receives light emitted from the LEDs 17. The front surface 16a is the light-exiting surface 16a, and light that enters the light guide plate 16 from the light-receiving face 16c exits from the light-exiting surface 16a towards the optical members 15 arranged above the light guide plate 16. In the present embodiment, the front surface (light-exiting surface) 16a and the rear surface 16b are parallel to each other. The two long-side edge faces 16c and 16d of the light guide plate 16 are parallel to each other and the two short-side edges 19e and 19f of the light guide plate 16 are parallel to each other. The light guide plate 16 is configured to have a greater thickness than the optical members 15, described later. The light guide plate 16 is housed inside the chassis 14 with the rear surface 16b of the light guide plate 16 facing the bottom plate 14a through the reflective sheet 19.

The light guide plate 16 is disposed inside the chassis 14 such that the edge face (light-receiving face) 16c on one long-side of the light guide plate 16 is disposed on the light source positioning member 18 side, the edge face 16d on the other long-side of the light guide plate 16 is disposed on the side wall 14d side, the edge face 16e on one short-side of the light guide plate 16 is disposed on the side wall 14e side, and the edge face 16f on the other short-side of the light guide plate 16 is disposed on the side wall 14f side. The rear surface 16b of the light guide plate 16 is covered by the reflective sheet 19 arranged on the bottom plate 14a. A plurality of locking pins (not shown) are provided on the bottom plate 14a of the chassis 14. The penetrating holes (not shown) through which the respective locking pins are inserted are provided in the periphery of the light guide plate 16. The light guide plate 16 is positioned above the bottom plate 14a of the chassis 14 with the respective locking pins inserted into the penetrating holes. A plurality of positioning holes are also provided in the periphery of the reflective sheet 19, and the reflective sheet 19 is also positioned above the bottom plate 14a of the chassis 14 by the respective locking pins described above.

Inside the chassis 14, the light-receiving face 16c of the light guide plate 16 faces a light-emitting face 17a of the respective LEDs 17 mounted on the driving substrate 113 with a prescribed gap maintained therebetween. The portion (edge) of the bottom plate 14a of the chassis 14 extending beyond the light-receiving face 16c is the extending edge 141. The first attaching section 18b of the light source positioning member 18 described above is detachably fixed to this extending edge 141. A bottom 113c of the driving substrate 113 that is attached to the first positioning section 18a is sandwiched between the first positioning section 18a and the extending edge 141. The bottom 113c of the driving substrate 113 contacts the first attaching section 18b and is supported by the first attaching section 18b. If the bottom 113c of the driving substrate 113 is sandwiched between the first positioning member 18a and the extending edge 141 and supported by the first attaching section 18b in this manner, then it is possible to prevent positional deviations and the like of the driving substrate 141. In other words, the position of the driving substrate 141 can be reliably secured by the light source positioning member 18.

The light emitted from the respective LEDs 17 enters the light guide plate 16 from the light-receiving face 16c. The light that has entered the light guide plate 16 is reflected by the reflective sheet 19 and the like while progressing inside the light guide plate 16, and exits as planar light from the light-exiting surface 16a towards the optical members 15.

Reflective parts that reflect light or scattering parts that scatter light in the light guide plate 16 and the like are patterned so as to have a prescribed inner surface portion on the front surface (light-exiting surface) 16a or the rear surface 16b of the light guide plate 16. This makes it so that light that exits from the light-exiting surface 16a will have a uniform planar distribution.

As shown in FIG. 2 and the like, the optical members 15 have horizontally-long rectangular shapes when viewed from the front in a plan view, in a manner similar to the liquid crystal panel 11, the light guide plate 16, and the like. The optical members 15 are arranged above the light-exiting surface 16a of the light guide plate 16 and cover this light-exiting surface 16a. The optical members 15 are constituted by a diffusion sheet 15a, a lens sheet 15b, and a reflective polarizing sheet 15c. The light exiting from the light-exiting surface 16a receives optical effects while passing through the optical members 15 towards the rear surface 11b of the liquid crystal panel 11.

The frame 20 has a frame-shaped member along the periphery of the liquid crystal panel 11 and the light guide plate 16 and is made of a synthetic resin mold. The frame 20 has a black color and has light blocking characteristics. The frame 20 attaches to the chassis 14 while pressing substantially the entire periphery of the front surface (light-exiting surface) 16a of the light guide plate 16 and the optical members 15. The frame 20 includes a frame body 20a that faces the front surface (light-exiting surface) 16a of the light guide plate 16, and a peripheral wall 20b that extends downward from the outer edge of this frame body 20a. The inner front (inner edge) portion of the frame body 20 is lower than the portion of the frame body 20a on the outside (outer edge), and serves as a placement section 20c on which the periphery of the liquid crystal panel 11 is placed. Among the outer edges of the rectangular frame body 20, the peripheral wall 20b is provided on the two short-side outer edges and one long-side outer edge. The other long-side outer edge does not have the peripheral wall 20b. The peripheral wall 20b covers the respective side walls 14e, 14f, and 14d of the chassis 14 from above by being arranged on the outside of the respective side walls 14e, 14f, and 14d of the chassis 14. The frame 20 is detachably fixed to the chassis 14 by a fixing structure (not shown) such as a screw. Among the outer edges of the frame body 20a of the frame 20, the portion where the peripheral wall 20b is not provided is arranged on the driving substrate 113 side and covers the extending edge 141 of the chassis 14 and the respective LEDs 17 mounted on the driving substrate 113. The periphery of the liquid crystal panel 11 is placed on the placement section 20c on the inner periphery of the frame 20. The respective flexible substrates 111 provided on one edge of the liquid crystal panel 11 have a bent shape that goes around the outside of the frame body 20a of the frame 20 and faces the bottom plate 14a side (the extending edge 141 side) of the chassis 14. The driving substrate 113 is connected to the end of the flexible substrates 111 facing the bottom plate 14a side.

The liquid crystal panel 11 is attached to the chassis 14 such that the periphery of the liquid crystal panel 11 is sandwiched by the frame 20 and the bezel 13 described above that covers this frame 20 from the front. When viewed in a plan view from the front, the bezel 13 includes a bezel body 13a that is shaped like a frame so that the display surface 11a is exposed from the inside, and the bezel body 13a covers the display surface 11a from the front side thereof. The bezel also includes four bezel side walls 13c, 13d, 13e, and 13f that extend downwards from the respective outer edges of this bezel body 13a. The external appearance of the bezel body 13a is a rectangular shape when seen in a plan view from the front. The cross-section of the bezel body 13a has a substantially flat plate shape. One of the bezel side walls 13c is arranged on one long-side outer edge of the bezel body 13a, and the bezel side wall 13d is arranged on the other long-side outer edge. One of the bezel side walls 13e is arranged on one short-side outer edge of the bezel body 13a, and the bezel side wall 13f is arranged on the other short-side outer edge. The bezel 13 is detachably fixed to respective side walls 14d, 14e, and 14f of the chassis 14 and to the light source positioning member 18 fixed to the chassis 14 by a fixing structure (not shown) such as a screw. Specifically, the bezel side walls 13d, 13e, and 13f are detachably fixed to the respective side walls 14d, 14e, and 14f of the chassis 14 along with the peripheral wall 20b of the frame 20 and the like. The bezel side wall 13c is detachably fixed to the first positioning section 18a of the light source positioning member 18.

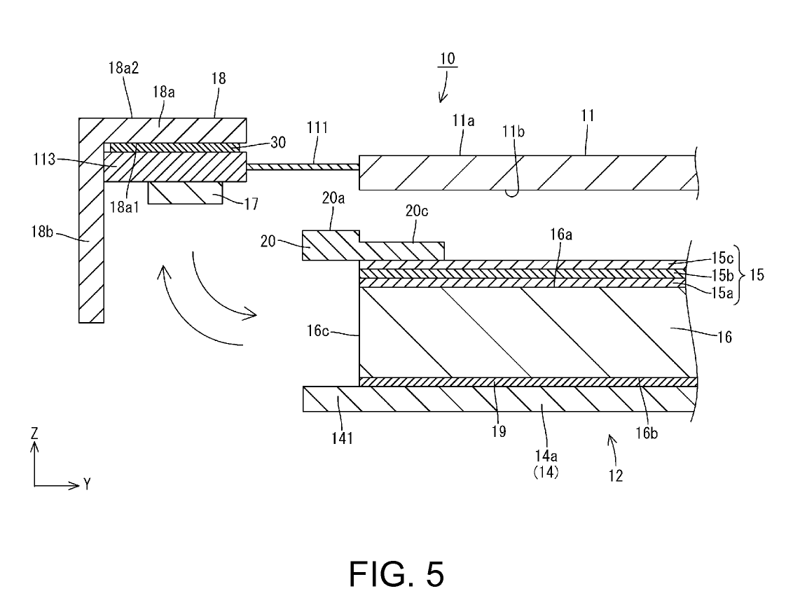

FIG. 5 is a schematic view for explaining a detaching process of the liquid crystal panel 11 for the backlight device 12. The assembly process of the liquid crystal display device 10 will be explained below with reference to FIG. 5 and the like. The focus will be on the process of attaching the liquid crystal panel 11 to the backlight device 12. First, the reflective sheet 19 is placed on the bottom plate 14a of the chassis 14 that forms a part of the backlight device 12. The light guide plate 16 is then positioned on the reflective sheet 19 with respect to the bottom plate 14a of the chassis 14. Thereafter, the optical members 15 are arranged on the front surface 16a of the light guide plate 16 in such a way as to cover this front surface 16a (the light-exiting surface 16a). The frame 20 is attached to the chassis 14 and presses the periphery of the optical members 15.

After the frame 20 is attached to the chassis 14, the periphery of the liquid crystal panel 11 is placed on the placement section 20c and the liquid crystal panel 11 attaches to the frame 20. Before the frame 20 is attached, the driving substrate 113 of the liquid crystal panel 11 is adhered to the light source positioning member 18 using the adhesive sheet 30. After the liquid crystal panel 11 is placed on the placement section 20c of the frame 20, the light source positioning member 18 is fixed to the extending edge 141 of the chassis 14 such that the LEDs 17 mounted on the mounting face 18a1 of the driving substrate 113 face the edge face (light-receiving face) 16c of the light guide plate 16 with prescribed gaps therebetween. Thereafter, the bezel 13 is fixed to the side wall 14d and the like of the chassis 14 and the first positioning section 18a of the light source positioning member 18 so as to sandwich the periphery of the liquid crystal panel 11 between the frame 20 and the bezel 13. With such a process, the liquid crystal display device 10 can be obtained.

Next, the process of removing the liquid crystal panel 11 from the backlight device 12 will be explained with reference to FIG. 5 and the like. The liquid crystal panel 11 is sometimes removed from the liquid crystal display device 10 (backlight device 12) post-assembly for a variety reasons, such as changing the liquid crystal panel 11, quality inspection, and the like. In the present embodiment, the driving substrate 113 on which the LEDs 17 are mounted is removed along with the liquid crystal panel 11 from the backlight device 12 (the chassis 14 side). When removing the liquid crystal panel 11 from the backlight device 12, first the bezel 13 is removed from the side wall 14d and the like of the chassis 14. The bezel 13 is fixed by a fixing structure such as a screw to the side wall 14d and the like of the chassis 14 and the first positioning section 18a of the light source positioning member 18. Thus, if the fixing structure such as the screw is removed, then the bezel 13 will be removed from the chassis 14 and the like.

The first attaching section 18b of the light source positioning member 18 is detachably fixed to the extending edge 141 (bottom plate 14a) of the chassis 14 by a fixing structure such as a screw. Therefore, if the fixing structure is removed, then the light source positioning member 18 will be removed from the chassis 14. The driving substrate 113 is adhered to the first positioning section 18a of the light source positioning member 18 through the adhesive sheet 30. Accordingly, when removing the liquid crystal panel 11 from the frame 20, the driving substrate 113 on which the LEDs 17 are mounted can also be removed along with the light source positioning member 18. In other words, in the present embodiment, the driving substrate 113 on which the LEDs 17 are mounted can be removed along with the liquid crystal panel 11 without removing the driving substrate 113 from the light source positioning member 18 and while still being attached to the light source positioning member 18. After the liquid crystal panel 11 is removed, the driving substrate 113 should be appropriately peeled from the adhesive sheet 30 to remove the driving substrate 113 from the light source positioning member 18.

When the power source of the liquid crystal display device 10 of the present embodiment is turned ON, power is received from the power source P and various types of signals from the controller board (not shown) are supplied to the liquid crystal panel 11 to control the display driving thereof and to drive the lighting of the respective LEDs 17 forming a part of the backlight device 12. When light is emitted from the respective LEDs 17 due to driving of the respective LEDs 17, the light enters the inside of the light guide plate 16 from the light-receiving face 16c thereof. The light that has entered the light guide plate 16 progresses therethrough while being reflected and the like by the reflective sheet 19 arranged on the rear side of the light guide plate 16. This light exits as planar light from the front surface (light-exiting surface) 16a of the light guide plate 16 towards the optical members 15. The light that has exited the light guide plate 16 becomes substantially uniform planar light by passing through the optical members 15 and then illuminates the rear surface of the liquid crystal panel 11. The liquid crystal panel 11 uses the light illuminating the rear surface 11b of the liquid crystal panel 11 to display images on the display surface 11a thereof.

In the liquid crystal display device (display device) 10 of the present embodiment, the LEDs (light sources) 17 are mounted on the mounting surface 113a of the driving substrate 113, which drives display of the liquid crystal panel (display panel) 11. The driving substrate 113 is electrically connected to the liquid crystal panel (display panel) 11 by the flexible substrates (flexible wiring substrates) 111, which are flexible. The light source positioning member 18 is fixed to the opposite surface 113b of the mounting surface 113a on the drive substrate 113 such that the LEDs (light sources) 17 face the light-receiving face 16c of the light guide plate 16 with prescribed gaps therebetween. The light source positioning member 18 can be detached from the extending edge 141 of the chassis 14. Accordingly, in the liquid crystal display device (display device) 10, the light source positioning member 18 can be removed from the chassis 14; therefore, when removing the liquid crystal panel (display panel) 11, the driving substrate 113 can be removed from the chassis 14 with ease. Conversely, after the liquid crystal panel 11 is attached, the light source positioning member 18 to which the driving substrate 113 is attached can be attached to the chassis 14, thereby making the attachment work easier.

Conventionally, when LEDs are mounted on a driving substrate, the driving substrate is fixed to a side wall of the chassis. In a liquid crystal display device having such a driving substrate, it is necessary to remove the light guide plate, optical members, and the like in advance from inside the chassis when removing the liquid crystal panel along with the driving substrate. This is because it is necessary to ensure working space within the chassis for the removal of the driving substrate from the side wall. In the chassis, there are slight gaps between the driving substrate and the light-receiving face of the light guide plate in consideration of thermal expansion and the like of the light guide plate, but conventionally it is very difficult to remove the driving substrate from the side wall of the chassis even with these available gaps. As a countermeasure, the light source positioning member 18 to which the driving substrate 113 is attached can be removed from the chassis 14, and thus, it is easier to remove the driving substrate 113 along with the liquid crystal panel 11 from the chassis 14, as in the liquid crystal display device 10 of the present embodiment.

In the liquid crystal display device 10 of the present embodiment, the light source positioning member 18 is detachably fixed to the chassis 14 as a part of the chassis 14. In this manner, if the light source positioning member 18 is detachably fixed to the chassis 14, then the driving substrate 113 can be removed from the chassis 14 with ease if the light source positioning member 18 is removed from the chassis 14.

In the liquid crystal display device 10 of the present embodiment, the bottom 113c of the driving substrate 113 may be sandwiched between the first positioning section 18a and the extending edge 141 and supported by the first attaching section 18b. In this manner, if the bottom edge 113c of the driving substrate 113 is sandwiched between the first positioning section 18c and the extending edge 141 and supported by the first attaching section 18b, then the driving substrate 113 can be reliably positioned by the light source positioning member 18. This also makes it easier for heat generated by the LEDs 17 and the like to move from the driving substrate 113 to the bottom plate 14a of the chassis 14 and the light source positioning member 18 (the first attaching section 18b).

In the liquid crystal display device 10 of the present embodiment, the first positioning section 18a and the first attaching section 18b both have a plate shape and are perpendicular to each other. When the light source positioning member 18 has this type of configuration, it is easy to produce (manufacture) the light source positioning member 18.

In the liquid crystal display device 10 of the present embodiment, the driving substrate 113 and the first positioning section 18a of the light source positioning member 18 are adhered to each other through the adhesive sheet 30 that is thermally conductive. Accordingly, the heat generated by the LEDs 17 and the like can be efficiently moved to the light source positioning member 18 through the driving substrate 113 and the adhesive sheet 30. In other words, the driving substrate 113 can efficiently dissipate heat (cool down).

In the liquid crystal display device 10 of the present embodiment, the portions (so-called frame portions) surrounding the display surface 11a of the liquid crystal panel 11 can be configured to be narrow and small.

### Embodiment 2

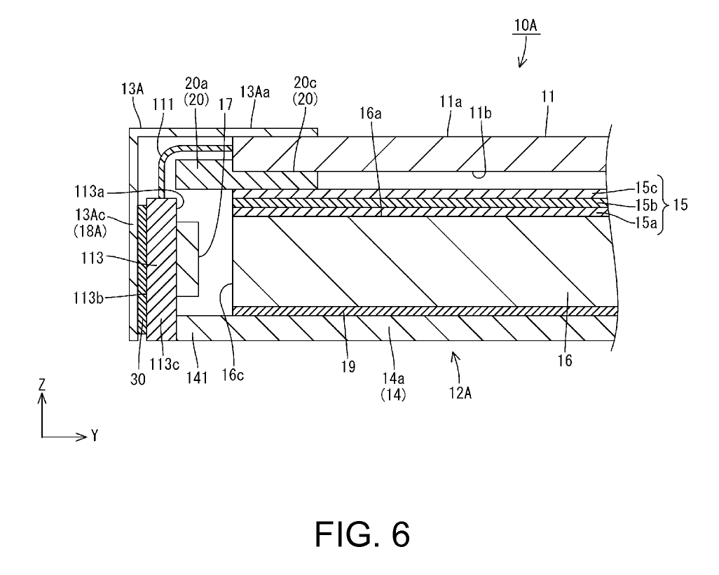

Next, Embodiment 2 of the present invention will be explained with reference to FIG. 6. In the respective embodiments below, portions that are the same to those in Embodiment 1 are given the same reference characters as in Embodiment 1, and a detailed explanation thereof will be omitted. Repeated explanations of the effects will also be omitted. In the present embodiment, a liquid crystal display device 10A having a backlight device 12A is shown as an example.

FIG. 6 is a cross-sectional view of the liquid crystal display device 10A according to Embodiment 2. The cross-sectional configuration of the liquid crystal display device 10A shown in FIG. 6 corresponds to the cross-sectional configuration of the liquid crystal display device 10 of Embodiment 1 shown in FIG. 4. The basic configuration of the liquid crystal display device 10A of the present embodiment is similar to the configuration in Embodiment 1. However, the liquid crystal display device 10A of the present embodiment differs from Embodiment 1 in that a bezel side wall 13Ac of a bezel 13A functions as a light source positioning member 18A. As shown in FIG. 6, the light source positioning member 18 of Embodiment 1 is not provided in the liquid crystal display device 10A of Embodiment 2. In the present embodiment, a driving substrate 113 on which LEDs 17 are mounted is directly adhered to the bezel side wall 13Ac of the bezel 13A via an adhesive sheet 30. This bezel side wall 13Ac extends downwards from the outer edge of a bezel body 13Aa. The tip (bottom) of the bezel side wall 13Ac reaches the position of a bottom plate 14a of a chassis 14. In the liquid crystal display device 10A of the present embodiment, the driving substrate 113 has a screw (not shown) inserted from the outside of the bezel side wall 13Ac towards the bottom plate (an extending edge 141) of the chassis 14, and this screw fixes the driving substrate 113 to the chassis 14. In other words, the driving substrate 113 is detachably fixed to the chassis 14. The bezel 13A (bezel side wall 13Ac) is also detachably fixed to the chassis 14 and the driving substrate 113.

The driving substrate 113 may be fixed with a portion (bezel side wall 13Ac) of the bezel 13A, as in the liquid crystal display device 10A of the present embodiment. In the liquid crystal display device 10A of the present embodiment, if the light source positioning member 18A includes a portion of the bezel 13A (bezel side wall 13Ac), then the bezel 13A can be removed from the chassis 14 along with the light source positioning member 18A (bezel side wall 13Ac). As a result, the driving substrate 113 can be removed from the chassis 14 with ease. When removing a liquid crystal panel 11 from a backlight device 12, first the bezel 13 is removed. In a manner similar to Embodiment 1, the bezel 13 is detachably attached to the chassis 14 by a fixing structure such as a screw, and thus, the bezel 13 can be removed from the chassis 14. The driving substrate 113 is attached to the inner side of the bezel side wall 13Ac of the bezel 13 through the adhesive sheet 30. Therefore, when removing the bezel 13 from the chassis 14 side, the driving substrate 113 may also be peeled off from the bezel 13. Thereafter, the liquid crystal panel 11 is removed from the chassis 14 along with the driving substrate 113. When re-attaching the liquid crystal panel 11 to the chassis 14 side, the driving substrate 113 may be adhered to the bezel 13 using a new sheet of the adhesive sheet 30.

In the liquid crystal display device 10A of the present embodiment, a bottom 113c of the driving substrate 113 is sandwiched between the bezel side wall 13Ac, which is the light source positioning member 18A, and the extending edge 141 of the chassis 14. In this manner, if the driving substrate 113 is sandwiched, then the driving substrate 113 is further reliably fixed to the bezel 13A. The heat generated by the LEDs 17 mounted on the driving substrate 113 can more easily move from the driving substrate 113 to the bottom plate 14a of the chassis 14.

In the liquid crystal display device 10A of the present embodiment, a portion of the bezel 13A is used as the light source positioning member 18A; thus, the frame portion of the liquid crystal display device 10A can be made narrower and smaller.

### Embodiment 3

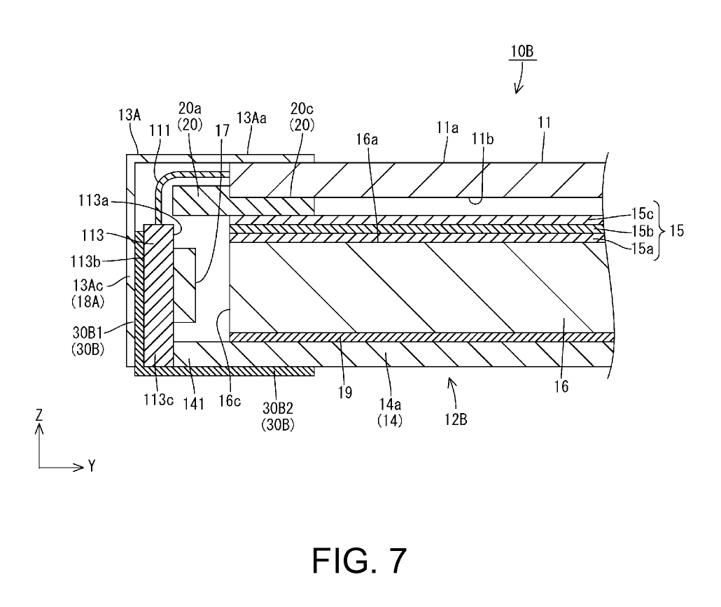

Next, Embodiment 3 of the present invention will be explained with reference to FIG. 7. In the present embodiment, a liquid crystal display device 10B having a backlight device 12B is shown as an example. FIG. 7 is a cross-sectional view of the liquid crystal display device 10B according to Embodiment 3. The cross-sectional configuration of the liquid crystal display device 10B shown in FIG. 7 corresponds to the cross-sectional configuration of the liquid crystal display device 10A of Embodiment 2 shown in FIG. 6. The basic configuration of the liquid crystal display device 10B of the present embodiment is similar to the configuration of Embodiment 2. However, in the liquid crystal display device 10B of the present embodiment, an adhesive sheet 30B for adhering a driving substrate 113 to a bezel 13A differs from the configuration in Embodiment 2. As shown in FIG. 7, the adhesive sheet 30B of the present embodiment is configured to be longer (larger) than the configuration in Embodiment 2.

The adhesive sheet 30B is thermally conductive, in a manner similar to Embodiments 1 and 2. As shown in FIG. 7, the adhesive sheet 30B has an interposed adhesive part 30B1 that is interposed between an opposite surface 113b of the driving substrate 113 and the inner face of a bezel side wall 13Ac, and an extended adhesive part 30B2 that extends from this interposed adhesive part 30B1 and adheres to an extending edge 141. The adhesive sheet 30B is a double-sided adhesive, but has a non-adhesive treatment (by being covered with a protective film, for example) on the outer surface of the extended adhesive part 30B2 (the surface of the side not adhered to the chassis 14). The adhesive sheet 30B is attached to the opposite surface 113b of the driving substrate 113, the outer surface of the extending edge 141 and the bottom surface of the driving substrate 113 such that a mounting surface 113a of the bottom 113c of the driving substrate 113 is pushed against the extending edge 141. Specifically, the interposed adhesive part 30B1 is attached to the opposite surface 113b of the driving substrate 113, and the extended adhesive part 30B2 that extends from this interposed adhesive part 30B1 is attached to the outer surface of the extending edge 141 and the bottom surface of the driving substrate 113.

As with the liquid crystal display device 10B of the present embodiment, the bezel side wall 13Ac (light source positioning member 18A) of the bezel 13A, but the driving substrate 113 will also be reliably positioned with respect to the extending edge 141 of the chassis 14. In other words, positional deviations or shifts of the driving substrate 113 will be suppressed by the adhesive sheet 30B.

### Embodiment 4

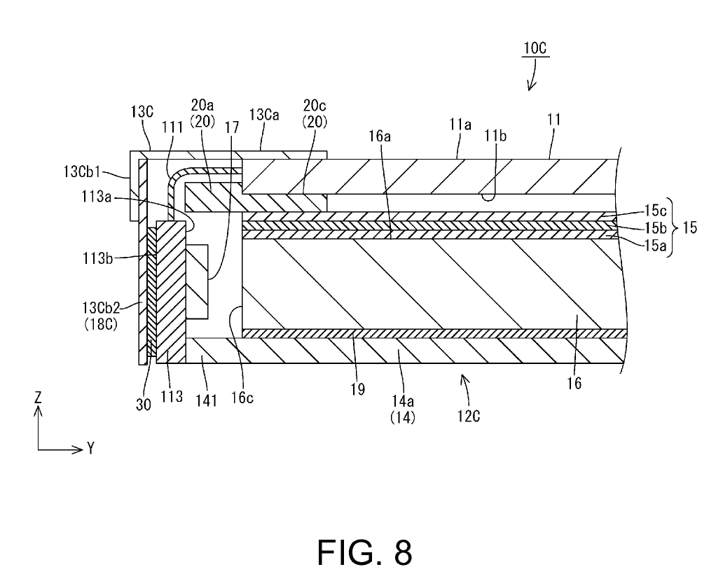

Next, Embodiment 4 of the present invention will be explained with reference to FIG. 8. In the present embodiment, a liquid crystal display device 10C having a backlight device 12C is shown as an example. FIG. 8 is a cross-sectional view of the liquid crystal display device 10C according to Embodiment 4. The cross-sectional configuration of the liquid crystal display device 10C shown in FIG. 8 corresponds to the cross-sectional configuration of the liquid crystal display device 10A of Embodiment 2 shown in FIG. 6. The basic configuration of the liquid crystal display device 10C of the present embodiment is similar to the configuration of Embodiment 2. However, a bezel 13C of the liquid crystal display device 10C of the present embodiment differs from the configuration in Embodiment 2. Specifically, a bezel side wall 13Cb2 of the bezel 13C can be detached from a bezel body 13Ca of the bezel 13C and also serves as a light source positioning member 18C that positions a driving substrate 113 on which LEDs 17 are mounted.

A plate-shaped flange 13Cb1 that extends downwards is provided on the outer edge of the bezel body 13Ca of the bezel 13C. The plate-shaped bezel side wall 13Cb2 is disposed on the inner side of this flange part 13Cb1 with a portion of the bezel side wall 13Cb2 in contact with the flange part 13Cb1. The flange part 13Cb1 of the bezel body 13Ca and the bezel side wall 13Cb2 are detachably fixed to each other by a fixing structure (not shown) such as a screw. The driving substrate 113 is adhered to the inner side of the bezel side wall 13Cb2 through an adhesive sheet 30. A fixing structure (not shown) such as a screw is inserted into an extending edge 141 of a chassis 14 from the outside of the bezel side wall 13Cb2, and this fixing structure detachably fixes the bezel side wall 13Cb2 to the extending edge 141 of the chassis 14. In a similar manner, the driving substrate 113 is detachably fixed to the extending edge 141 of the chassis 14 by the fixing structure.

As with the liquid crystal display device 10C of the present embodiment, if the bezel side wall 13Cb2 that is the light positioning member 18C is detachably fixed to the bezel 13C (the bezel body 13Ca), then only the bezel 13C (the bezel body 13Ca) can be removed from the chassis 14 during removal of a liquid crystal panel 11 from the liquid crystal display device 10C (from the chassis 14 side). In other words, the bezel 13C (the bezel body 13Ca) can be removed from the chassis 14 side while the light source positioning member 18C (the bezel side wall 13Cb2) remains on the chassis side 14. Accordingly, removing the light source positioning member 18C (bezel side wall 13Cb2) from the chassis 14 becomes easier. If the light source positioning member 18C (bezel side wall 13Cb2) is removed from the bezel 13C (bezel body 13Ca), then the light source positioning member 18C (bezel side wall 13Cb2) will have a size that is easy to handle during assembly of the liquid crystal display device 10C, and it will be easier to attach the light source positioning member 18C (bezel side wall 13Cb2) to the chassis 14 side.

### Embodiment 5

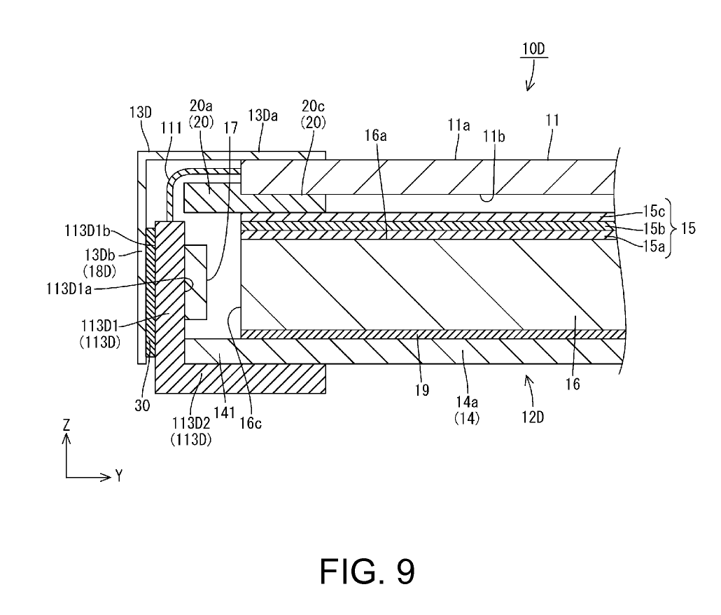

Next, Embodiment 5 of the present invention will be explained with reference to FIG. 9. In the present embodiment, a liquid crystal display device 10D having a backlight device 12D is shown as an example. FIG. 9 is a cross-sectional view of the liquid crystal display device 10D according to Embodiment 5. The cross-sectional configuration of the liquid crystal display device 10D shown in FIG. 9 corresponds to the cross-sectional configuration of the liquid crystal display device 10A of Embodiment 2 shown in FIG. 6. The basic configuration of the liquid crystal display device 10D of the present embodiment is similar to that of Embodiment 2. However, a driving substrate 113D of the liquid crystal display device 10D of the present embodiment differs from the configuration in Embodiments 1 and 2. Specifically, the driving substrate 113D has a rising portion 113D1 that is a flexible printed circuit board (FPC) and that rises with respect to a bottom plate 14a of a chassis 14, and an extended fixture 113D2 that extends from this rising portion 113D1 and is detachably fixed to an extending edge 141.

LEDs 17 are mounted on a mounting surface 113D1a of the rising portion 113D1 of the driving substrate 113D, in a manner similar to Embodiment 1. An adhesive sheet 30 is adhered to an opposite surface 113D1b of this mounting surface 113D1a, and this adhesive sheet 30 is used to adhere the driving substrate 113D to a bezel side wall 13Db of a bezel 13D. In the present embodiment, this bezel side wall 13Db functions as a light source positioning member 18D, and this bezel side wall 13Db positions the LEDs 17 mounted on the driving substrate 113D with respect to a light-receiving face 16c of a light guide plate 16.

A prescribed wiring pattern (not shown) is formed on the driving substrate 113D, in a manner similar to Embodiment 1 and the like. In the present embodiment, the wiring pattern is mainly formed on the inside of the mounting surface 113D1a of the rising portion 113D1. The bottom of the rising portion 113D1 (namely, the end of the rising portion 113D1 on the extended fixture 113D2 side) is sandwiched by the bezel side wall 13Db, which is the light source positioning member 18D, and the extending edge 141 of the chassis 14. The extended fixture 113D2 connecting to the rising portion 113DD1 is bent towards the extending edge 141 side of the chassis 14. The extended fixture 113D2 is attached to the outer surface of the bottom plate 14a of the chassis 14 through an adhesive sheet (not shown) that is thermally conductive. If this extended fixture 113D2 is attached to the chassis 14, then the bottom of the rising portion 113D1 on which the LEDs 17 are mounted will be pressed against the extending edge 141 and will make it easier for heat from the driving substrate 113D (heat generated by the LEDs 17 and the like) to escape to the bottom plate 14a side of the chassis 14.

As with the liquid crystal display device 10D of the present embodiment, if the driving substrate 113D has the rising portion 113D1 and the extended fixture 113D2, then it will be easy to arrange the driving substrate 113D such that the LEDs 17 face the light-receiving face 16c of the light guide plate 16 with prescribed gaps therebetween. This is because the rising portion 113D1 of the driving substrate 113D is adhered to the bezel side wall 13Db by the adhesive sheet 30, and the extended fixture 113D2 is adhered to the outer surface of the extending edge 141 (bottom plate 14a) of the chassis 14 by a different adhesive sheet (not shown). In this manner, it becomes easier to reliably arrange (fix) the driving substrate 113D to the prescribed location by the section (area) where the driving substrate 113D is adhered to becoming larger.

In the present embodiment, during removal of the liquid crystal panel 11 from the liquid crystal display device 10D, the extended fixture 113D2 of the driving substrate 113D may be detached from the bottom plate 14a (the extending edge 141) of the chassis 14 in advance. If the extended fixture 113D2 adhered to the bottom plate 14a (extending edge 141) by a prescribed adhesive sheet (not shown) is pulled at a prescribed force, then the extended fixture 113D2 will detach from the bottom plate 14a (the extending edge 141). In such a state, if the bezel 13D and the liquid crystal panel 11 are removed from the liquid crystal display device 10D, then the driving substrate 113D can also be removed along with these from the chassis 14 side (from the liquid crystal display device 10D).

### Embodiment 6

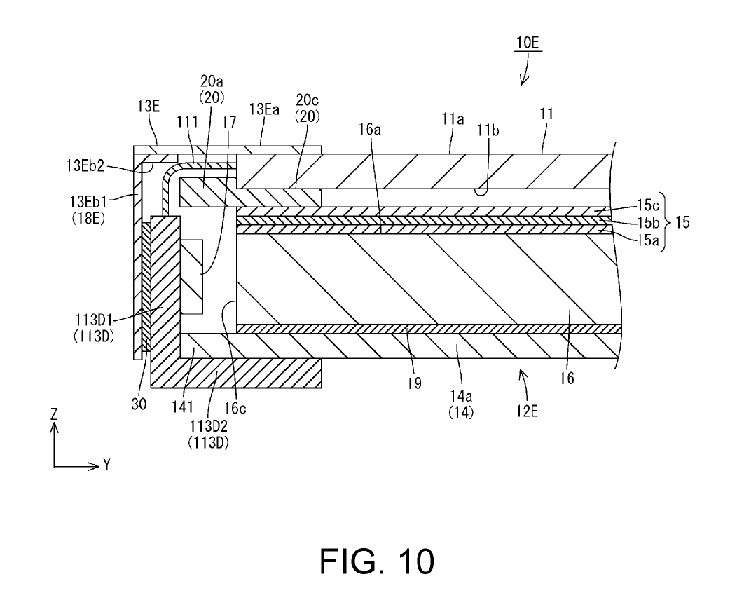

Next, Embodiment 6 of the present invention will be explained with reference to FIG. 10. In the present embodiment, a liquid crystal display device 10E having a backlight device 12E is shown as an example. FIG. 10 is a cross-sectional view of a liquid crystal display device 10E according to Embodiment 6. The cross-sectional configuration of the liquid crystal display device 10E shown in FIG. 10 corresponds to the cross-sectional configuration of the liquid crystal display device 10D of Embodiment 5 shown in FIG. 9. The basic configuration of the liquid crystal display device 10E of the present embodiment is similar to the configuration of Embodiment 5. However, a bezel 13E of the liquid crystal display device 10E of the present embodiment differs from the configuration in Embodiment 5. Specifically, in the present embodiment, a bezel side wall 13Eb1 that is a section of the bezel 13E is detachably fixed to a bezel body 13Ea.

In the present embodiment, the bezel side wall 13Eb1 functions as a light source positioning member 18E. A rising portion 113D1 of the driving substrate 113D is adhered to the bezel side wall 13Eb1 through an adhesive sheet 30. A protrusion 13Eb2 that protrudes towards the inner side of the chassis 14 (a liquid crystal panel 11 side) is disposed on the top of the bezel side wall 13Eb1. The outer edge of the bezel body 13Ea is placed on this protrusion 13Eb2, and the bezel side wall 13Eb1 is detachably fixed to the bezel body 13Ea. In a multilayer section including the protrusion 13Eb2 of the bezel side wall 13Eb1 and the outer edge of the bezel body 13Ea, a screw (fixing structure, not shown) is inserted from the front of the bezel 13E towards the rear thereof, fixing the bezel side wall 13Eb1 to the bezel body 13Ea.

The bottom of the bezel side wall 13Eb1 is also fixed to an extending edge 141 of the chassis 14 by a screw (fixing member, not shown). The screw is screwed into the extending edge 141 of the chassis 14 while penetrating the driving substrate 113B. Accordingly, the bezel side wall 13Eb1 is detachably fixed to the chassis 14. The driving substrate 113B is also detachably fixed to the chassis 14.

As in the present embodiment, the bezel side wall 13Eb1, which is a section of the bezel 13E, may be used as the light source positioning member 18E. The bezel side wall 13Eb1 may be detachably fixed to a bezel body 13Da of the bezel 13E (see Embodiment 4).

### Embodiment 7

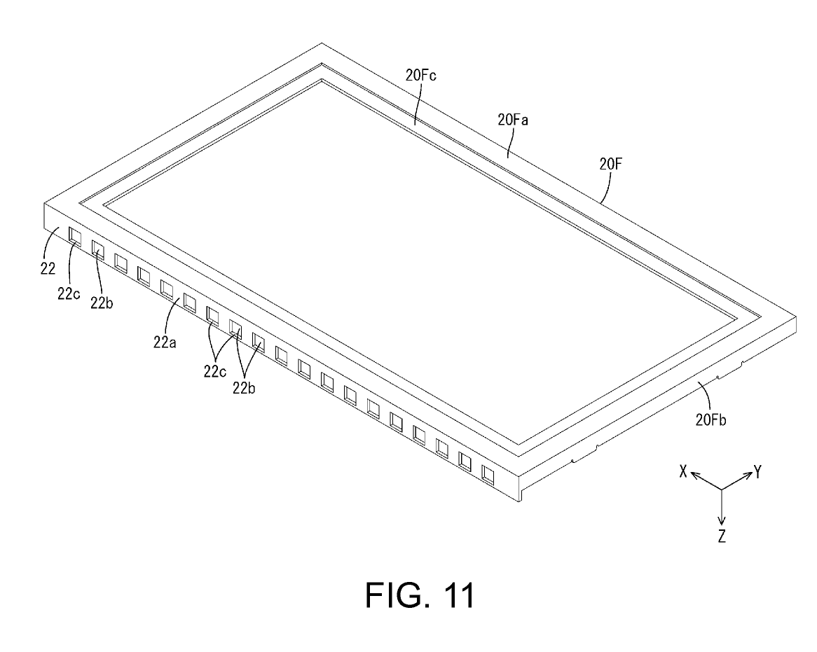

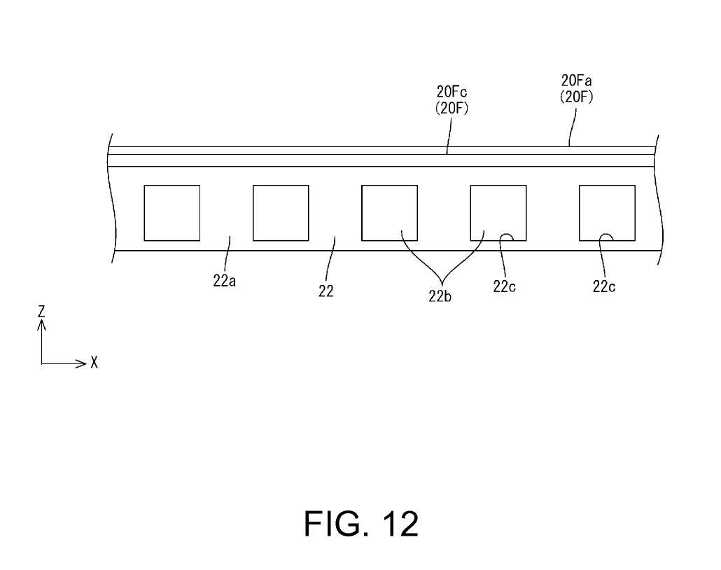

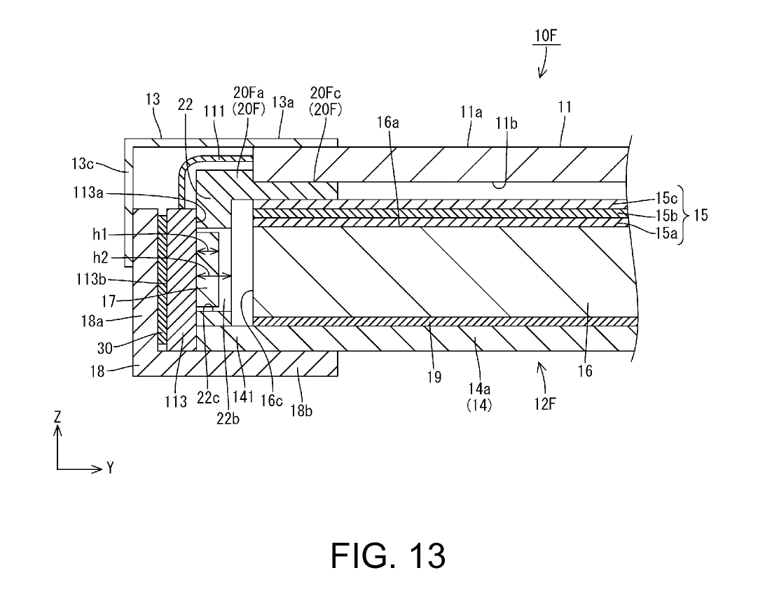

Embodiment 7 of the present invention will be explained below with reference to FIGS. 11 to 14. In the present embodiment, a liquid crystal display device 10F having a backlight device 12F is shown as an example. FIG. 11 is a perspective view of a frame 20F of Embodiment 7, FIG. 12 is a view explaining a protective member 22 of the frame 20F, and FIG. 13 is a cross-sectional view of the liquid crystal display device 10F of Embodiment 7. The cross-sectional configuration of the liquid crystal display device 10F shown in FIG. 13 corresponds to the cross-sectional configuration of the liquid crystal display device 10 of Embodiment 1 shown in FIG. 4. As shown in FIG. 13, the basic configuration of the liquid crystal display device 10F of the present embodiment is similar to the configuration of Embodiment 1. However, the structure of the frame 20F in the liquid crystal display device 10F of the present embodiment is different. Specifically, in the present embodiment, the protective member 22 is attached to the portion of the outer edge of the frame 20F arranged on a driving substrate 113 side. This protective member 22 is used to prevent LEDs 17 from contacting a light-receiving face 16c of a light guide plate 16 when a liquid crystal panel 11 and the driving substrate 113 on which the LEDs 17 are mounted are attached to a chassis 14, or when the liquid crystal panel 11 and the driving substrate 113 are removed from the liquid crystal display device 10F.

As shown in FIG. 11, the frame 20F of the present embodiment has a frame-shaped frame body 20Fa that faces a front surface (light-exiting surface) 16a of the light guide plate 16, and a peripheral wall 20Fb that extends downwards from the outer edge of this frame body 20Fa. The front inner (inner edge) portion of the frame body 20F is a step lower than the rest of the frame body 20F, and this portion serves as a placement section 20Fc where the periphery of the liquid crystal panel 11 will be placed, in a manner similar to Embodiment 1. Among the outer edges of the rectangular frame body 20Fa, the peripheral wall 20Fb is provided on the two short-side outer edges and one long-side outer edge, in a manner similar to Embodiment 1. In the present embodiment, the protective member 22 is disposed on the remaining long-side of the frame-shaped body 20Fa. This protective member 22 is a part of the frame 20F and is integrally formed with the frame F20.

The protective member 22 includes an elongated plate-shaped (belt-shaped) protective body 22a across the long-side direction of the frame body 20Fa, an insertion part 22b where the respective LEDs 17 mounted on the driving substrate 113 are inserted, and a protective wall 22c that surrounds the insertion part 22b such that the LEDs 17 do not protrude into the light-receiving face 16c side of the light guide plate 16. The protective body 22a (the protective member 22) is arranged between the mounting surface 113a of the driving substrate 113 and the light-receiving face 16c of the light guide plate 16 during attaching of the frame 20F to the chassis 14.

As shown in FIG. 12, a plurality of the insertion parts 22b are arranged in a row along the long-side direction of the protective body 22a. FIG. 12 shows a part of the protective member 22 as seen from the inner side of the frame 20F. The shape of the insertion parts 22b is a square that is slightly larger than the LEDs 17 when seen from an insertion direction of the LEDs 17. The respective insertion parts 22b are arranged on the protective body 22a such that the respective LEDs 17 on the driving substrate 113 can be respectively inserted into the insertion parts 22b. The thickness of the protective wall 22c surrounding the insertion parts 22b (the thickness in the insertion direction of the LEDs 17) is configured such that the tip (light-emitting face 17a) of the LEDs 17 does not protrude into the light-exiting surface 16c side of the light guide plate 16 when the LEDs 17 are inserted into the respective insertion parts 22b. In the present embodiment, the outer surface of the protective member 22 is in contact with the mounting surface 113a of the driving substrate 113. A thickness h2 of the protective wall 22c is configured to be greater than a height h1 of the LEDs 17 protruding towards the light-receiving face 16c of the light guide plate 16 from the mounting surface 113a of the driving substrate 113.

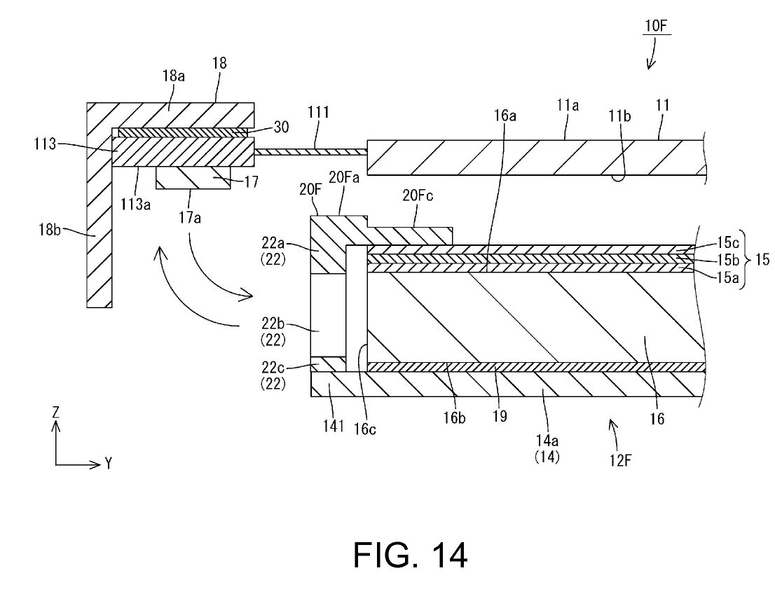

FIG. 14 is a schematic view for explaining a detaching process of the liquid crystal panel 11 for the backlight device 12F according to Embodiment 7. As shown in FIG. 14, the frame 20F is attached to a prescribed location on the backlight device 12F. The protective member 22 is placed on an extending edge 141 while maintaining a prescribed gap from the light-receiving face 16c of the light guide plate 16. When the liquid crystal panel 11 is attached to the backlight device 12F (the chassis 14 side) having this type of frame 20F, then the driving substrate 113 adhered to the light source positioning member 18 is also attached to a prescribed location on the chassis 14. The LEDs 17 mounted on the driving substrate 113 are inserted into the respective insertion parts 22b of the protective member 22. As described above, the thickness h2 of the protective wall 22c surrounding the insertion parts 22b is configured to be larger than the height h1 of the LEDs 17. Therefore, when attaching the driving substrate 113 to the prescribed location on the chassis 14, contact is avoided between the LEDs 17 and the light-receiving face 16c of the light guide plate 16. Conversely, contact is also avoided between the LEDs 17 mounted on the driving substrate 113 and the light-receiving face 16c of the light guide plate 16 when removing the liquid crystal panel 11 from the chassis 14.

It is possible for the light guide plate 16 to deviate in position and move towards the driving substrate 113 during the attachment or removal work of the liquid crystal panel 11. However, in the present embodiment, the protective member 22 is interposed between the light-receiving face 16c of the light guide plate 16 and the mounting surface 113a of the driving substrate 113; therefore, this protective member 22 can prevent contact between the LEDs 17 and the light guide plate 16. Accordingly, damage and the like to the LEDs 17 by being in contact with the light-receiving face 16c of the light guide plate 16 is avoided.

### Other Embodiments

The present invention is not limited to the embodiments shown in the drawings and described above, and the following embodiments are also included in the technical scope of the present invention, for example.

(1) In the respective embodiments above, the LEDs 17 are mounted on the source-side of the driving substrate, but in other embodiments the LEDs may be mounted on the gate side of the driving substrate.

(2) In the respective embodiments above, the bottom of the driving substrate is sandwiched between the light source positioning member (first positioning section) and the extending edge, but in other embodiments the extending edge of the bottom plate of the chassis may attach to the light positioning member (first positioning section) and the bottom of the driving substrate may be arranged above (on the front) the extending edge.

(3) In the respective embodiments above, the frame was used as a member to support the liquid crystal panel, but in other embodiments the liquid crystal panel may be attached to the backlight device without the use of the frame. The liquid crystal panel may be placed on the front surface (light-exiting surface) of the light guide plate through the optical members, for example.

(4) In Embodiment 7 above, the protective member is integrally formed with the frame, but in other embodiments the protective member may be detached from the frame (in other words, the protective member may be a separate part from the frame). In this case, the protective member that is a separate part would be directly attached to the mounting surface of the driving substrate by an adhesive agent or the like, for example.

(5) In Embodiment 7 above, the protective member is the same material as the frame (namely, a light-blocking material), but in other embodiments the protective member may be a resin material with excellent light transmissive characteristics. In this case, the protective member can be integrally formed with the frame by using double-molding, for example.

(6) In the respective embodiments above, the driving substrate is adhered to the light source positioning member by using an adhesive sheet, but in other embodiments the driving substrate may be adhered to the light source positioning member using another adhering method (a fixing structure such as a screw, for example).

(7) In the respective embodiments above, the driving substrate adhered to the light source positioning member is detachably fixed using a fixing structure such as a screw during attachment to the chassis. In other embodiments, the driving substrate may be detachably fixed using an adhesive agent, or the light source positioning member and the chassis may be detachably fixed to each other using another fixing structure (in which one area has a protrusion and the other area has a recess and these are detachably fixed by the protrusion fitting into the recess, for example).

(8) In Embodiment 7 above, the protective member has a rectangular shape and is a continuous part of the frame, but in other embodiments the frame may be divided into a plurality of components.

(9) In Embodiment 1 above, a television receiver TV was shown as an example of the liquid crystal display device, but in other embodiments the liquid crystal display device may be used with a mobile phone, personal digital assistants, or the like, for example. In other embodiments, the display device may not be provided with the tuner.

(10) In Embodiment 1 above, the respective colored portions of the color filters of the liquid crystal panel 11 were shown as being R, G, or B as an example, but in other embodiments, the respective colored portions may be four or more colors. In other embodiments, the liquid crystal display device may perform black-and-white display.

(11) In Embodiment 1, TFTs were used as the switching elements of the liquid crystal display device, but in other embodiments, switching elements besides TFTs (thin-film diodes (TFDs), for example) may be used.

### DESCRIPTION OF REFERENCE CHARACTERS

10 liquid crystal display device (display device)
11 liquid crystal panel (display panel)
11a display surface
11b rear surface
12 backlight device (illumination device)
13 bezel
14 chassis
14l extending edge
15 optical members
16 light guide plate
16a front surface of light guide plate (light-exiting surface)
16b rear surface of light guide plate
16c light-receiving face
17 LEDs (light sources)
18 light positioning member
19 reflective sheet
20 frame
22 protective member
111 flexible substrates (flexible wiring substrates)
113 driving substrate (source substrate)
113a mounting surface
113b opposite surface
TV television receiver

1. A display device, comprising:
light sources;
a light guide plate having a light-receiving face on one edge face thereof that receives light emitted from the light sources, and a light-exiting surface on one surface of the light guide plate where light received by the light-receiving face exits, the light guide plate being a plate-shaped member;
a display panel having a rear surface that faces the light-exiting surface of the light guide plate and that is illuminated by light exiting from said light-exiting surface, and a display surface on a side opposite to said rear surface of the display panel, the display surface being where images are displayed by light illuminating the rear surface;
a driving substrate having a mounting surface on which the light sources are mounted, the driving substrate driving display of the display panel;
flexible wiring substrates that electrically connect the display panel to the driving substrate;
a chassis that has an extending edge that extends beyond the light-receiving face of the light guide plate and that faces a surface of the light guide plate opposite to the light-exiting surface; and
a light source positioning member that is detachably mounted on the chassis and that is adhered to a surface of the driving substrate opposite to the mounting surface thereof such that the light sources face the light-receiving face with a prescribed gap therebetween.

2. The display device according to claim 1, wherein the light source positioning member is detachably fixed to the chassis.

3. The display device according to claim 1,
wherein the light source positioning member has a first positioning section adhered to a surface of the driving substrate opposite to the mounting surface thereof, and a first attachment section that extends to this first positioning section and that is detachably fixed to the chassis.

4. The display device according to claim 3, wherein a bottom of the driving substrate is sandwiched between the first positioning section and the extending edge and supported by the first attachment section.

5. The display device according to claim 3, wherein the first positioning section and the first attachment section both have plate shapes and are perpendicular to each other.

6. The display device according to claim 1, further comprising a frame-shaped bezel that covers a periphery of the display panel such that the display surface is exposed,
wherein the light source positioning member is a part of the bezel.

7. The display device according to claim 1, further comprising a frame-shaped bezel that covers a periphery of the display panel such that the display surface is exposed,
wherein the light source positioning member is detachably fixed to the bezel.

8. The display device according to claim 1, further comprising an adhesive sheet that is interposed between the light source positioning member and the driving substrate and that adheres the driving substrate to the light source positioning member.

9. The display device according to claim 8,
wherein the adhesive sheet has an interposed adhesive part that is interposed between the light source positioning member and the driving substrate and an extended adhesive part extending from this interposed adhesive part and adhered to the extending edge.

10. The display device according to claim 8, wherein the adhesive sheet has thermally conductive characteristics.

11. The display device according to claim 6,
wherein the driving substrate includes a rising portion that rises from the chassis and that includes the mounting surface, and an extended fixture that continues from this rising portion and that is detachably fixed to the extending edge, the rising portion being in contact with the extending edge.

12. The display device according to claim 1, further comprising a protective member that includes:
a body arranged between the mounting surface of the driving substrate and the light-receiving face of the light guide plate;
insertion sections that are holes going through this body and that are where the respective light sources are inserted; and
a protective wall that surrounds the insertion sections such that the light sources do not extend into the light-receiving face of the light guide plate.

13. The display device according to claim 12, further comprising a frame that attaches to a periphery of the liquid crystal display panel from the rear surface side thereof,
wherein the protective member is a part of the frame.

14. The display device according to claim 13, wherein the display panel is a liquid crystal panel having liquid crystal sealed between a pair of substrates.

15. A television receiver, comprising the display device according to claim 13.
